(19) United States
(12) Patent Application Publication
(10) Pub. No.: US 2013/0141900 A1
(43) Pub. Date: Jun. 6, 2013

(54) LIGHT EMITTING UNIT FOR CONTINUOUS LIGHT PRODUCTION

(71) Applicant: Wiley Keith Lane, Kingsburg, CA (US)

(72) Inventor: Wiley Keith Lane, Kingsburg, CA (US)

(21) Appl. No.: 13/337,114

(22) Filed: Dec. 24, 2011

Related U.S. Application Data
(63) Continuation-in-part of application No. 13/310,210, filed on Dec. 2, 2011, now abandoned.

(51) Int. Cl. F21L 4/00

(52) U.S. Cl. 362/183

(57) ABSTRACT

A light emitting unit for continuous production of light energy that can be utilized for a variety of light applications, including with an apparatus adapted to convert light energy to electricity when insufficient sunlight is available. The light emitting unit comprises a light emitting device electrically connected to a rechargeable battery, a vibrator motor electrically connected to the battery, a drive motor electrically connected to the vibrator motor, a shaft interconnecting the drive motor and a disc, and one or more magnets on the disc. The vibrator motor has a tip magnet that is positioned opposite the magnets on the disc to rotate the disc and shaft to produce electricity from the drive motor that is used to recharge the battery. In one configuration, a photocell electrically connects to the battery and the vibrator motor and a safety circuit is disposed between the battery and the light emitting device.

### CROSS-REFERENCE TO RELATED APPLICATIONS

This patent application is a continuation-in-part of U.S. patent application Ser. No. 13/310,210 filed Dec. 2, 2011.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to apparatuses and systems that are configured to produce light. More particularly, the present invention relates to such light producing apparatuses and systems that produce light on at least a substantially continuous basis. Even more particularly, the present invention relates to such light producing apparatuses and systems that can be utilized to continuously produce light so as to power a light-powered generation machine and generate electricity therefrom with the extra electricity generated to charge batteries that provides power to maintain a system-startup.

B. Background

Motors and other machines for converting a source of input energy to an output in the form of rotational torque that is delivered through an output shaft have been generally available for many years. The rotational torque at the output shaft is commonly utilized to produce electricity via a generator. As well known, the input energy for such machines has been provided by moving water, gravity, blowing wind, solar energy, fossil fuels, nuclear materials and a variety of other sources. More recently, there has been a desire to utilize energy from the readily available, clean and renewable energy sources, such as water, wind or the sun, instead of using the limited more polluting sources of energy, such as petroleum, coal, uranium and the like. Another source of energy that has been utilized to generate electricity is the magnetic energy that is stored in permanent magnets. As is well known, when the same polarity ends of two magnets are placed near each other the repulsion force of the two magnetic fields will repel the magnets and, conversely, when the opposite polarity ends of two magnets are placed near each other the attraction force of the magnetic fields will draw the two magnets toward each other, assuming one or both of the magnets are allowed to move. An advantage of utilizing permanent magnets is that the energy available from such magnets is considered to be relatively constant and capable of providing long operating life.

With regard to producing electricity, apparatuses and systems for converting a source of energy to useful power for generating electricity have been generally available for many years. A common arrangement for generating electricity is a large power plant that delivers the produced electricity to the end user over long distance, often very long distance, transmission lines. As is commonly known, such power plants are very complicated and very expensive, requiring large capital investment in the power plant and the transmission lines. Presently, most large power plants rely on traditional sources of energy, such as oil, natural gas, coal, nuclear, stored water and the like to produce electricity. There is a strong effort to provide alternative apparatuses and systems to power machines, particularly generators for producing electricity, that utilize energy sources which have less environmental impact, generally by being more readily available, cleaner and, preferably, renewable. For instance, many people and organizations have been attempting to utilize wind, solar, tidal and geothermal resources as a source of power to operate generators for the production of electricity. Although such sources of energy have been well known and, to some extent, in use for many years, it has only been relatively recent that substantially increased efforts have been directed towards improving the efficiency of these energy systems so they may be capable of generating more electricity. Currently, such alternative energy systems are a relatively small percentage of the total electricity production.

In general, the increased push for apparatuses and systems that generate electricity without utilizing conventional, non-renewable and polluting energy sources, particularly hydrocarbon fuels, is a direct result of the known limited supply of these energy sources and the negative impact the use of such sources has had on the environment. Unfortunately, at the same time that the supplies of conventional sources of energy have become scarcer and the impacts of such sources have become more well known, the demand for electricity has substantially increased. As well known, the increase in demand is driven by a number of factors, including but not limited to the expansion in the number of devices that are powered by electricity, such as computers, air conditioning, audio systems, kitchen appliances and a vast number of other devices, and the rapid expansion in the number of people who have the desire and access to such devices. As an example, many people desire to make telephones, computers and other electronic devices more widely available to others and to replace dirty burning machines, including standard hydrocarbon fuel-based motor vehicles, with machines powered by electricity. While such goals are generally laudable, an unintended consequence of increasing the availability of electronic devices and producing electricity-based vehicles is a substantial increase in the demand for electricity. The increase in demand for electricity will have to be supplied by those apparatuses and systems that are available, which, at least presently, primarily rely on hydrocarbon-based fuels to provide the necessary power. As the need for electricity increases, the supply of fossil fuels to produce electricity is further reduced, the environmental impacts of these fuels worsen and the cost of using electricity increases. Even though the cost of electricity is anticipated to rise and there may be availability problems, most experts expect that the demand for electricity will substantially increase during the foreseeable future. In fact, consumers generally expect that electricity will be available to them when they need it, whether to operate an appliance, energize a light source, operate a machine and provide power to operate motor vehicles.

Although electricity is generally produced and provided to the public by large power plants, there is often a need for localized production of electricity for use at or very near the location where it is produced. One advantage of such electricity production is that it eliminates the requirement to transmit the electrical power over long distances, thereby substantially eliminating the cost to build such long distance transmission lines, the cost of acquiring the right-of-way for the land and the use of the land to support those lines. For areas that are somewhat off of the normal power grid, the cost of building the necessary transmission lines and the cost to maintain those lines can be significant. To be effective, however, a localized electricity producing apparatus and system must be of sufficient size to supply the needed amount of electricity and must be able to reliably supply that electricity. Presently, small wind, water and solar generators and generating systems for localized production of electricity are not commonly utilized by those who could otherwise benefit from such apparatuses and systems.

With regard to smaller scale solar powered electricity generating systems, these systems typically comprise a plurality of solar panels fixedly mounted on the roof of the user's home or business. The solar panel mounting system must be sufficiently strong to support the panels above the roof and prevent damage to the solar panels and roof during wind and other weather conditions. Many different types of mounting systems are presently in use to support solar panels on the roof of a building. Unfortunately, the initial cost of purchasing and installing solar panels is often prohibitive to most people. In addition, because the solar panels require sunlight, they have limited ability to produce electricity during cloudy, foggy, rainy, snowy and other inclement weather conditions and do not produce any electricity at night. For many parts of the United States and the world, the non-production times can significantly impact the benefits that would be otherwise achieved by the use of solar panels and, as a result, significantly impact the cost/benefit analysis of electrical generating systems relying on solar energy production. Although it is known to use light producing apparatuses and systems to supply the light needed by solar (or more accurately photovoltaic) panels, the presently available apparatuses and systems require too much power to allow efficient production of light therefrom for use as a continuous light source, particularly for electricity production from the light source.

What is needed, therefore, is an improved apparatus and system for producing light on a continuous basis that can be utilized as a light source for a variety of different uses, including generating electricity a light-powered electricity generating machine. Preferably, the apparatus and system should be configured to produce light on a continuous basis so the light energy therefrom may be used by a light-powered generator to generate electricity without being interrupted by the lack of sunlight during inclement weather and night hours. The apparatus and system should also be adaptable for a variety of other light energy uses. The preferred apparatus and system should be configured so as to be relatively simple to install and operate and relatively inexpensive to manufacture.

### SUMMARY OF THE INVENTION

The light emitting unit for continuous light production of the present invention provides the benefits and solves the problems identified above. That is to say, the present invention is a light emitting unit that is configured to produce light energy on a continuous basis. The light emitting unit of the present invention continuously and efficiently generates light energy for use to accomplish a wide variety of energy purposes, including light emission. In one embodiment, the light emitting unit of the present invention produces light energy that can be utilized to power photovoltaic cells that are configured as part of a magnetically levitated device which rotates magnets on a disc and mechanically connected to a shaft. This rotates the shaft operating a motor in reverse as a generator. The light emitting unit of the present invention comprises an electrically powered light emitting device that is electrically connected to a recharging system so it can produce light on a continuous basis and provide startup power to move the constituent parts when activated by a photocell triggered by darkness. In one use of the present invention, the light emitting unit provides light energy to an array of photovoltaic cells. The photovoltaic cells receiving light energy may be utilized to continuously generate electricity that will not be interrupted by the lack of sunlight during inclement weather and the night hours. The present light emitting unit can direct light energy to photovoltaic cells so as to energize a magnetically levitated device to rotate magnets relative to a coil and generate electricity therefrom. The light emitting unit producing the light to rotate the continuous power generation device. The light emitting unit is simple to install and operate and relatively inexpensive to manufacture.

The light emitting unit apparatus and system of the present invention comprises an electrically powered light emitting device that is powered by a rechargeable battery. The batteries are electrically connected to a power generator that recharges the battery. In one embodiment of the present invention, the power generator comprises a disc having a plurality of magnets that are attached thereto, a shaft which is attached to or integral with the disc, a drive motor that is connected to the shaft and a separate vibrator motor having a tip magnet attached thereto, with the tip magnet positioned opposite the magnets on the disc and magnetically opposed to those magnets so as to rotate the shaft and operate the drive motor in reverse to generate electrical current from the drive motor that recharges the rechargeable battery. The present light emitting unit can be utilized to provide light for a variety of light energy purposes. For instance, the light emitting unit of the present invention can be utilized to discharge light energy toward a light-powered electricity generating apparatus and system to generate electricity therefrom on a continuous basis when light energy from the sun is not available.

In one embodiment, the continuous power generation apparatus and system that can be utilized with the light emitting unit of the present invention has a light-powered magnetically levitated device with a rotor block having a plurality of sidewalls, a first drive shaft attached to a first end of the rotor block so as to extend outwardly therefrom and rotate therewith, a second drive shaft attached to a second end of the rotor block so as to extend outwardly therefrom and rotate therewith, a mechanism associated with the rotor block for rotating the rotor block in response to light energy from the light emitting unit (or the sun, if available), a mechanism associated with each of the first drive shaft and the second drive shaft for magnetically levitating the rotor block, a first drive shaft magnet attached to or mounted on the first drive shaft that rotates therewith, a second drive shaft magnet attached to or mounted on the second drive shaft that rotates therewith, a first conductor element associated with the first drive shaft magnet and a second conductor element associated with the second drive shaft magnet. Light from the light emitting unit rotates the rotor block, which rotates the drive shafts and the drive shaft magnets. The rotating drive shaft magnets rotate relative to stationary coils associated with each of the conductor elements to produce electricity therefrom. The rotating mechanism comprises a photovoltaic panel on each of the sidewalls of the rotor block, block wiring on the rotor block and a drive magnet magnetically engaged with the block wiring. The photovoltaic panels convert light to electrical current that is discharged to the block wiring. The drive magnet is positioned so as to magnetically engage the electrical current in the block wiring and rotate the rotor block. The levitating mechanism comprises a first support magnet on the first drive shaft, one or more first base magnets disposed in spaced apart relation to the first support magnet, a second support magnet on the second drive shaft and one or more second base magnets disposed in spaced apart relation to the second support magnet. The support magnets and base magnets associated therewith are cooperatively configured and positioned so as to levitate the rotor block and the two drive shafts. In a preferred configuration, the rotor block has a square cross-section that defines four sidewalls and the rotating mechanism comprises four photovoltaic panels, with one photovoltaic panel on each sidewall so as to dispose the photovoltaic panels at right angles to each other. The block wiring is disposed along edges that are located between adjacent panels. The light emitting unit of the present invention allows the magnetically levitated device to operate continuously regardless of the availability of sunlight.

A power generation system comprises the light emitting unit of the present invention, a light-powered magnetically levitated device that converts the light from the light source to electrical current and a grid-tie inverter that receives the electrical current from the device and delivers it to the end user or into a power grid or other electrical system. In one embodiment, the light-powered device can be configured as described above and the light source is the light emitting unit of the present invention, utilized alone or in combination with the sun. If delivering the electrical current to the end user, the grid-tie inverter connects to a breaker that connects to the user's service panel.

Accordingly, the primary aspect of the present invention is to provide a light emitting unit with the advantages discussed above and which overcomes the disadvantages and limitations associated with prior art apparatuses and systems for producing light.

It is an important aspect of the present invention to provide a light emitting unit that is configured for continuous light production.

It is an important aspect of the present invention to provide a light emitting unit comprising a rechargeable battery that is recharged by a power generator having a magnetic shaft with a plurality of magnets attached thereto, a drive motor connected to the magnetic shaft and a vibrator motor having a tip magnet attached thereto, with the tip magnet positioned opposite the magnets on the magnetic shaft and magnetically opposed to those magnets so as to rotate the magnetic shaft and generate electrical current.

It is an important aspect of the present invention to provide a light emitting unit that can be utilized as a light source for an apparatus and system to power a magnetically levitated device that rotates magnets on a shaft to interact with a coil to generate electricity.

It is also an important aspect of the present invention to provide a light emitting unit that directs light energy to a magnetically levitated device that is powered by photovoltaic cells configured power a magnetically levitated device that rotates a magnet inside a wire coil so as to efficiently, effectively and continuously generate electricity therefrom.

It is also an important aspect of the present invention to provide a light emitting unit that can be utilized to continuously provide light to generate electricity from a light-powered electricity generating apparatus and system when light energy is not available from the sun.

Another important aspect of the present invention is to provide a light emitting unit apparatus and system that is relatively simple to assemble and operate and relatively inexpensive to manufacture.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a power generation apparatus configured according to a first embodiment showing use of the sun as the light source to power a magnetically levitated device and generate electricity therefrom;

FIG. 2 is an end view of the rotor block of the magnetically levitated device of the apparatus of FIG. 1 taken through line 2-2 of FIG. 1;

FIG. 3 is an end view of the rotor block of the magnetically levitated device of the apparatus of FIG. 1 taken through line 3-3 of FIG. 1;

FIG. 4 is an end perspective view of the rotor block with one of the photovoltaic panels and the wires removed therefrom;

FIG. 5 is a schematic of a system utilizing the apparatus configured according to the embodiment of the present invention shown in FIG. 1;

FIG. 6 is a side view of a light generating unit configured according to one embodiment of the present invention for use with the apparatus of FIG. 1 and the system of FIG. 5; and

FIG. 7 is a side view of an alternative configuration for the light source utilized with the apparatus of FIG. 1 and the system of FIG. 5.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show and discuss certain shapes and configurations for the various components of the light emitting unit of the present invention, those skilled in the art will readily appreciate that this is merely for purposes of simplifying this disclosure and that the present invention is not so limited.

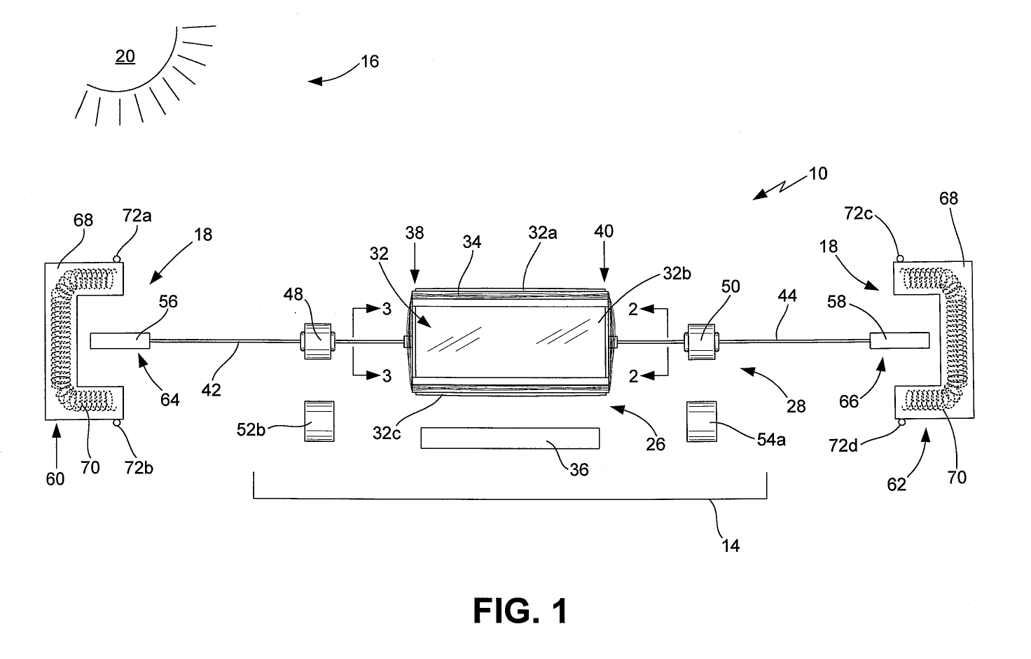

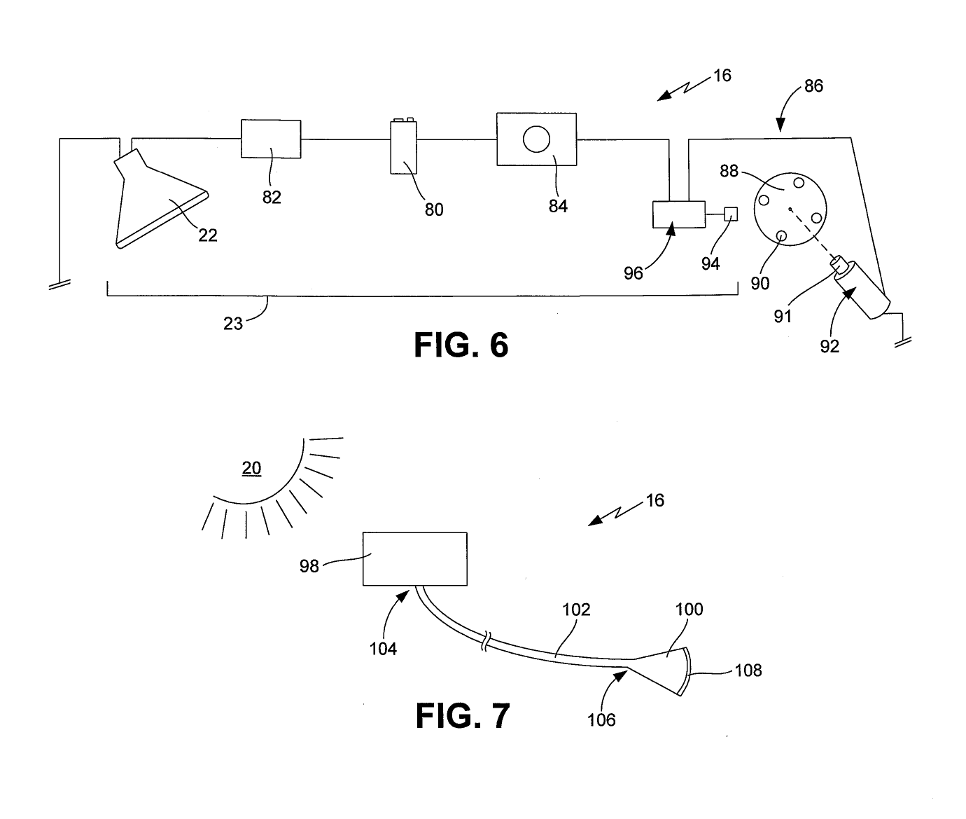

An apparatus for generating electricity is shown generally as 10 in FIGS. 1 through 4. As set forth in more detail below, the electricity generating apparatus 10 is utilized as part of a system 12 (shown in FIG. 5) for generating electricity that can be utilized by a home, business, school or other end user to power a plurality of lights, machines, apparatuses and other items therein or associated therewith. Apparatus 10 of the present invention generally comprises a light-powered magnetically levitated device 14, a light source 16 and a generating unit 18. As explained in more detail below, the magnetically levitated device 14, light source 16 and generating unit 18 operate together to produce electricity. Light from the light source 16 powers the magnetically levitated device 14 to operatively engage the generating unit 18 so as to produce electricity from the apparatus 10 for use in system 12 (which comprises the apparatus 10). In one embodiment, shown in FIGS. 1 and 5, the light source 16 is the sun 20, which supplies solar power to the photovoltaic panels, described below, contained in magnetically levitated device 14. In other embodiments, light source 16 is an electrically-powered light emitting device 22 that, preferably, receives electrical power from a rechargeable source of power as a component of the light emitting unit 23 of the present invention, an exemplary configuration of which is shown in FIG. 6 and explained in more detail below. In a preferred use of apparatus 10 and system 12, one or more apparatuses 10 are utilized to supply the power needs, whether all or a portion thereof, of the end user's requirements for electricity.

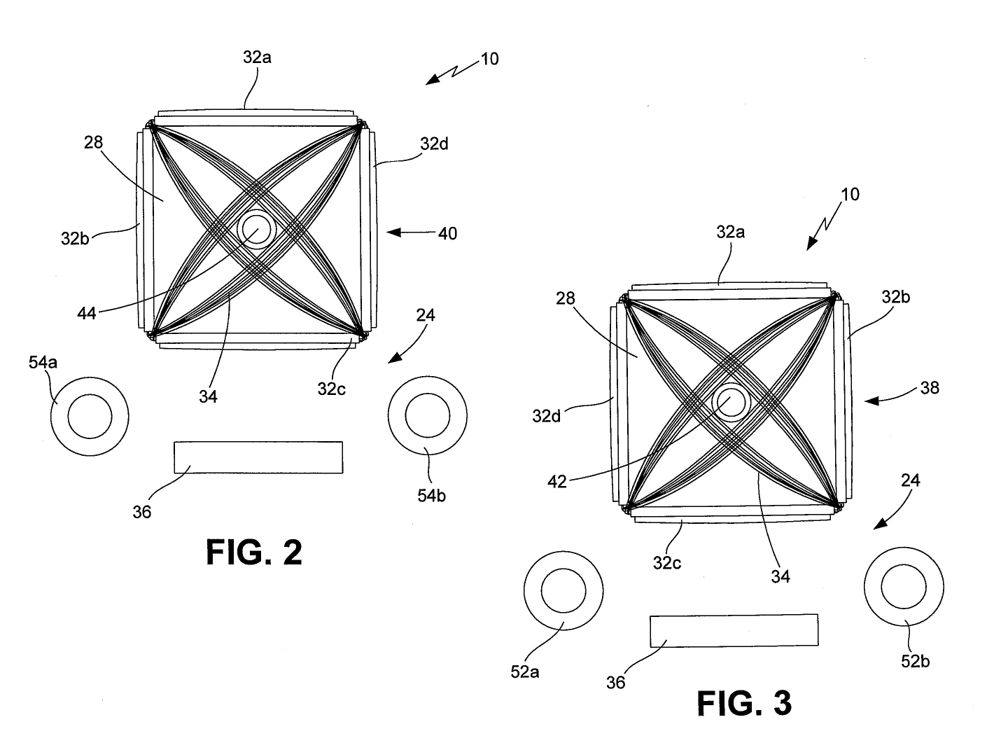

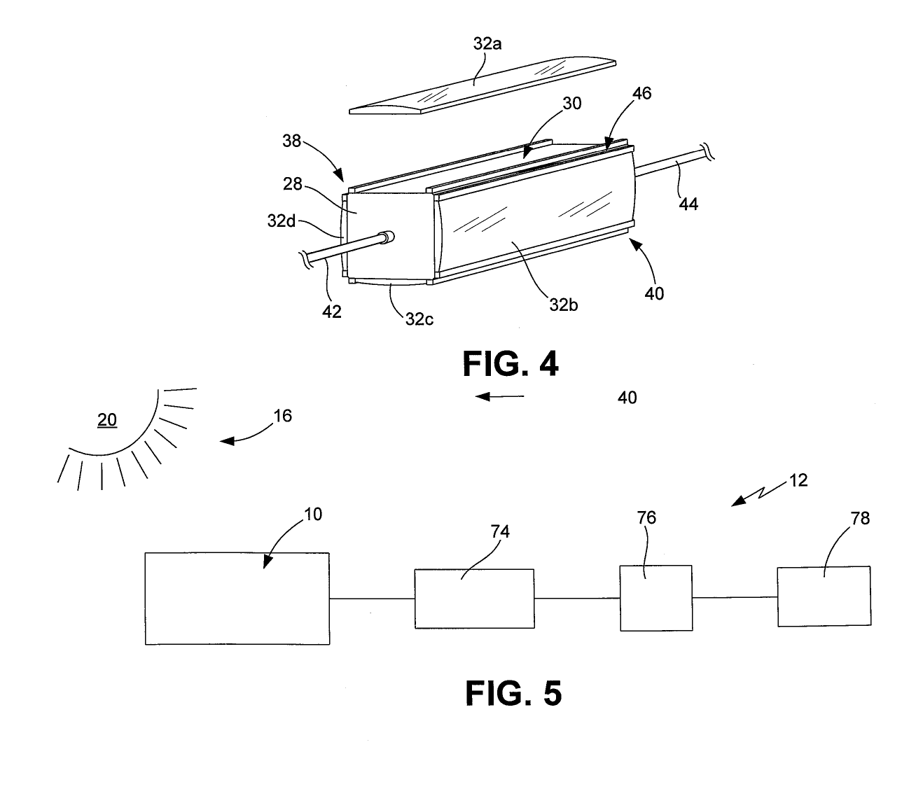

One of the key components of the power generation apparatus 10 (FIG. 1) and system 12 (FIG. 5) is the light-powered magnetically levitated device 14 (FIG. 1), which generally comprises rotating mechanism 24 and levitating mechanism 26, as shown in FIGS. 1 through 3. The rotating mechanism 24 of magnetically levitated device 14 includes rotor block 28 having one or more sidewalls 30 on which are strategically mounted a plurality of photovoltaic panels 32, best shown in FIG. 4, block wiring 34 and drive magnet 36, as shown in FIGS. 1 through 4. Although rotor block 28 can be of virtually any shape, in the preferred embodiment the rotor block 28 has at least a generally rectangular or square cross-section having four sidewalls 30 that each have a photovoltaic panel 32 mounted thereon, shown as panels 32a, 32b, 32c and 32d in FIGS. 2 through 4. As explained in more detail below, the photovoltaic panels 32 are selected and positioned on the rotor block 28 so as to receive light from the light source 16, feed electrical current through block wiring 34 and interact with the drive magnet 36 to rotate rotor block 28. The rotor block 28 has a first end 38 and second end 40. Fixedly mounted to the first end 38 of rotor block 28 so as to extend outwardly therefrom and rotate therewith is first drive shaft 42. Fixedly mounted to second end 40 of rotor block 28 so as to extend outwardly therefrom and rotate therewith is second drive shaft 44. The block wiring 34 electrically connects to photovoltaic panels 32 such that electrical current, which is converted from the light energy of light source 16 by photovoltaic panels 32, will pass through block wiring 34 when the light energy from light source 16 is received by the photovoltaic panels 32. The block wiring 34 is positioned at the edges 46 of the rotor block 28, typically in grooves or other recessed or recess-like features at or near the edges 46, so as to wrap around the ends 38/40 of rotor block 28, as best shown in FIGS. 2 through 4. As will be readily appreciated by those skilled in the art, when light energy from the light source 16 is received by the photovoltaic panels 32 and converted to electrical current thereby, the electrical current will flow through the block wiring 34 and be deflected by the drive magnet 36. The positioning of the photovoltaic panels 32 on the rotor block 28 will cause rotor block 28 to rotate, thereby successively exposing panels 32a, 32b, 32c and 32d (whether in this order or in reverse order) to receiving the light energy from light source 16, which rotates the drive shafts 42/44 extending from the ends 38/40 of rotor block 28. As explained in more detail below, rotation of the drive shafts 42/44 is utilized by generating unit 18 to generate electricity from apparatus 10.

In the preferred embodiment of apparatus 10 and system 12, rotating mechanism 24 of motor 14 is rotatably supported by levitating mechanism 26, as best shown in FIGS. 1 through 3. As will be readily appreciated by those skilled in the art, the levitating mechanism 26 is configured as a frictionless magnetic bearing that supports motor 14 in a manner that allows the rotor block 28, and therefore drive shafts 42/44, to rotate with as little rotational energy losses as possible. In the embodiment shown in the figures, a first support magnet 48 is fixedly mounted on the first drive shaft 42 so as to rotate therewith and a second support magnet 50 is fixedly mounted on the second drive shaft 44 so as to rotate therewith, as shown in FIG. 1. Fixedly mounted below support magnets 48/50, but generally in offset relation to the elongated axis through the drive shafts 42/44, are two pairs of base magnets 52 and 54, which are shown as first base magnets 52a and 52b in FIG. 3 and as second base magnets 54a and 54b in FIG. 2. The first base magnets 52a/52b are positioned below the first support magnet 48, but vertically offset therefrom, and second base magnets 54a/54b are positioned below the second support magnet 50, but vertically offset therefrom, in a manner that magnetically levitates the rotating mechanism 24 of magnetically levitated device 14 as the rotor block 28 and drive shafts 42/44 (with support magnets 48/50 thereon) rotate in response to the electrical current generated by the photovoltaic panels 32 from light source 16 interacting with drive magnet 36. Support magnets 48/50 and base magnets 52/54 of levitating mechanism 26 will need to be selected so as to cooperatively magnetically oppose each other to support rotating mechanism 24.

The magnetically levitated device 14, comprising rotating mechanism 24 and levitating mechanism 26, particularly with the rotor block 28 having four sidewalls 30 form what is popularly known as a Mendocino Motor. Rotor block 28 typically has a square cross-section with two sets of block wiring 34 and a solar or photovoltaic panel 32 attached to each side of the rotor block 28. The drive shafts 42/44 are positioned horizontally and extend from the ends 38/40 of the rotor block 28. The support magnets 48/50 on the drive shafts 42/44 provide levitation by magnetically repelling the base magnets 52/54. The drive magnet 36 under the rotor block 28 provides a magnetic field that engages the electrical field generated by the electrical current flowing through the block wiring 34. The electrical current in the block wiring 34 is generated by the photovoltaic panels 32 as a result of the light energy received from the light source 16, such as the sun 20, light emitting unit 23 or other light sources. When light from the light source 16 strikes one of the photovoltaic panels 32, it generates electric current that energizes the block wiring 34 that forms one of the rotor windings and forms a magnetic field which interacts with the magnetic field of the drive magnet 36 under the rotor block 28 to cause rotor block 28 to rotate. Rotation of the rotor block 28 positions the next photovoltaic panel 32 into the light from the light source 16 and energizes the block wiring 34 that forms the other rotor winding to create a current in the opposite direction to maintain the rotation of the rotor block 28. The rotation process repeats as rotor block 28 rotates. The rotation of rotor block 28 rotates the drive shafts 42/44 extending therefrom, which rotates support magnets 48/50 on the drive shafts 42/44. The rotating rotor block 28 and drive shafts 42/44 are magnetically levitated by the magnetic interaction between the support magnets 48/50 and the base magnets 52/54 to allow rotation thereof with as little energy loss as possible. As set forth in more detail below, the rotation of the drive shafts 42/44 is utilized to generate electricity.

As set forth above, the generating unit 18 is operatively engaged with the light-powered magnetically levitated device 14 such that the rotation of the drive shafts 42/44, resulting from the rotation of the rotor block 32 due to the conversion of light energy from light source 16 by the photovoltaic panels 32, will cause the generating unit to generate electricity 18. In the embodiment shown, the generating unit 18 generally comprises a first drive shaft magnet 56, second drive shaft magnet 58, first conductor element 60 and second conductor element 62, as best shown in FIG. 1. The first drive shaft magnet 56 is fixedly attached to the first drive shaft 42 and positioned at or near the distal end 64 thereof so as to be disposed in or at least substantially in the first conductor element 60. The second drive shaft magnet 58 is fixedly attached to the second drive shaft 44 and positioned at or near the distal end 66 thereof so as to be disposed in or at least substantially in the second conductor element 62. Rotation of the first drive shaft 42 will rotate the first drive shaft magnet 56 about the longitudinal axis of the first drive shaft 42. Likewise, rotation of the second drive shaft 44 will rotate the second drive shaft magnet 58 about the longitudinal axis of the second drive shaft 44. Each of the first conductor element 60 and the second conductor element 62 comprises a fixed housing 68 that houses one or more coils 70, typically made out of copper wire or the like, that are configured to be magnetically engaged by the rotating drive shaft magnets 56/58. The rotating magnetic flux resulting from the rotation of the drive shaft magnets 56/58 in the respective conductor elements 60/62 will penetrate the center or core of the coils 70 and then loop back around through the coils 70 to induce an electrical current therein. Coils 70 electrically connect to electrical connectors 72, shown as 72a, 72b, 72c and 72d in FIG. 1, that allow the electrical current generated by the apparatus 10 to be utilized in the system 12. As will be readily appreciated by those skilled in the art, the relative placement of the rotating drive shaft magnets 56/58 and the coils 70 in the fixed housing 68 needs to be selected so as to optimize the production of electricity from the apparatus 10 for use in system 12. As will also be readily appreciated by those skilled in the art, the apparatus 10 described above can be modified to produce electricity from a single combination of drive shaft, drive shaft magnet and conductor element, such as first drive shaft 42, first drive shaft magnet 56 and first conductor element 60 if apparatus 10 is otherwise properly configured, such as being balanced.

As shown in FIG. 5, one embodiment of the system 12 comprises a grid-tie inverter 74 which electrically connects, as shown in FIG. 1, to the electrical connectors 72 associated with each of the conductor elements 60/62 and converts the variable DC output of the from conductor elements 60/62 into a utility frequency AC current that can be utilized by the user of apparatus 10 and system 12, such as a local, off-grid electrical network, or fed into the commercial grid (depending on the needs or desire of the user). The configuration, operation and use of a grid-tie inverter 74 are well known by those skilled in the art. For use by the user, system 12 also includes a breaker 76 and service panel 78 that are associated with the home, business, office, school or other structure where the electricity from the apparatus 10 and system 12 will be utilized. The grid-tie inverter 74 electrically connects to the breaker 76 and the breaker 76 electrically connects to the service panel 78 to supply electricity to the equipment, machines, tools and other items inside or associated with the structure that utilizes electricity.

As set forth above and shown in FIGS. 1 and 5, the light energy used by the magnetically levitated device 14 to rotate the drive shaft magnets 56/58 relative to the conductor elements 60/62 can be provided by the sun 20, as the light source 16. The use of solar energy from the sun 20 to generate electrical current from photovoltaic panels 32 is generally well known. Although abundant solar energy is readily available in most areas of the country, there are a number of limitations to the use of the sun 20 as the light source 16. One such limitation is that light energy from the sun 20 is only available during the daylight hours, which is often not the entire daytime. Also, depending on the location and time of year, the amount of daylight hours can be somewhat limited. The production of electrical current from the photovoltaic panels 32 can also be limited by cloud cover, fog, rain, snow and other weather conditions. As a result, the preferred embodiment of the system 12 of the present invention includes a light emitting unit 23, such as shown in FIG. 6, that provides light energy for the apparatus 10 when solar energy is not available or not sufficiently available.

The light emitting unit 23 (FIG. 6) of the present invention comprises the electrically powered light emitting device 22 that discharges light energy toward the photovoltaic panels 32 for use by the magnetically levitated device 14.

As shown in FIG. 6, the light emitting device 22 is electrically connected to ground and to one or more rechargeable batteries 80 to supply the electrically powered light emitting device 22. As explained in more detail below, the light emitting unit 23 is configured to recharge the batteries 80 during its operation. In a preferred embodiment, the light emitting unit 23 also includes a safety circuit 82, typically comprising components such as diodes, capacitors, resistors and the like, disposed between the light emitting device 22 and battery 80. In the embodiment where the light emitting unit 23 is utilized for non-daylight hours (or insufficient daylight), light emitting unit 23 includes a photocell 84 that closes the circuit for the light emitting unit 23 so that it can begin to operate, by discharging light from light emitting device 22, when low or no natural light is detected. Preferably, photocell 84 is faced towards the south and configured to disconnect when natural light from the sun 20 is available. The photocell 84 electrically connects the battery 80 to a power generator 86 (FIG. 6) that, when the photocell 84 closes the circuit, recharges the battery 80 so that light emitting device 22 can be powered thereby.

In the embodiment shown in FIG. 6, power generator 86 comprises a plate or disc 88 having a plurality of magnets 90 attached or mounted thereto or thereon such that the rotation of the disc 88 will provide current to charge battery 80 and emit light from the electrically powered light emitting device 22. In one embodiment, the disc 88 is part of a round housing. Attached to or integral with the disc 88, typically at or near the center thereof, is shaft 91 that is mechanically attached to a drive motor 92, as shown in FIG. 6. The magnets 90 on the disc 88 are positioned opposite a vibrator tip magnet 94 that is mounted to the end of a vibrator motor 96. The polarity of the magnets 90 on the disc 88 and the polarity of the tip magnet 94 are the same to provide the magnetic oppositional force that causes the disc 88 to rotate, which rotates the shaft 91 and causes drive motor 92 to operate in reverse so as to act as a generator and generate electricity at the motor connection leads of the drive motor 92. As shown in FIG. 6, one end of the drive motor 92 is connected to ground and the other to vibrator motor 96. The vibrator motor 96 is also connected to battery 80 to feed power to the electrically powered light emitting device 22, which is also grounded. This configuration causes battery 80 to be charged and its output continually fed to the electrically powered light emitting device 22 (FIG. 6). When the circuit first closes, typically by operation of the photocell 84, the battery 80 supplies energy stored therein to initiate start-up of the system 12. The energy provided by the battery 80 begins operation of vibrator motor 96, which due to magnetic forces rotates disc 88 and the shaft 91 attached or integral thereto, which begins producing energy from the drive motor 92 to replenish the charge of battery 80.

An alternate configuration for the light source 16 is shown in FIG. 7.

In this embodiment, light source 16 comprises a solar collector 98 that collects sunlight from the sun 20 and distributes it to a light discharge unit 100 through a fiber optic cable 102. The solar collector 98 can be a canister, bucket or like container that is open at the top and/or sides thereof to catch light from the sun 20 that is connected to the inlet 104 into the fiber optic cable 102 so that light will be discharged from the outlet 106 of the fiber optic cable 102. In the preferred configuration of this embodiment, shown in FIG. 7, the outlet 106 of the fiber optic cable 102 connects to the light discharge unit 100 to better disperse the light over the photovoltaic panels 32. If desired, the light discharge unit 100 can have a lens 108 or other device to amplify the light from the solar collector 98. The light source 16 of this embodiment has the advantage of being able to utilize light from the sun 20 to power the apparatus 10 and system 12 during the daylight hours while being able to place the apparatus 10 inside a room, basement or other area of a building or other structure.

In use, light energy from the light emitting unit 23 (FIG. 6) of the present invention can be utilized for a wide variety of light energy purposes. In one embodiment, light energy from the light emitting unit 23 is directed toward the photovoltaic panels 32 of the magnetically levitated device 14, which converts the light energy to electrical current that is discharged through the block wiring 34. The induced current generated by the photovoltaic panels 32 and transmitted through the block wiring 34 is deflected away from the stationary magnetic field of the drive magnet 36. Because there are four photovoltaic panels 32 at right angles to each other, as one set of rotor wiring is deflected away the other set of rotor wiring comes under the influence of the magnetic field of drive magnet 36 to cause rotation of the rotor block 28 and, therefore, the drive shafts 42/44 in one direction. The rotating shafts 42/44 are supported by the levitating mechanism 26, comprising the support magnets 48/50 on the drive shafts 42/44, respectively, that are disposed above the base magnets 52/54, to provide a frictionless bearing that minimizes energy loss. The drive shaft magnets 56/58 are positioned at the distal ends 64/66 of drive shafts 42/44 rotate inside the coils 70 of the conductor elements 60/62. Rotation of the drive shaft magnets relative to the stationary coils 70 causes an electrical current to be induced in the coils 70 as the rotating magnetic field crosses perpendicular to the wires that form the coils 70. The current inside the coils 70 is connected to the electrical connectors 72, which provides the connection to the grid-tie inverter 74 (FIG. 5) that distributes the electricity to the end user or the electric service provider's power grid.

While there are shown and described herein one or more specific embodiments of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein, with regard to its assembly, size, shape and use and with regard to the materials used in its construction. For instance, there are a number of components described herein that can be replaced with equivalent functioning components to accomplish the objectives of the present invention.

What is claimed is:

1. A light emitting unit for producing light energy, comprising:
a rechargeable battery;
a light emitting device electrically connected to said rechargeable battery;
a vibrator motor electrically connected to said rechargeable battery, said vibrator motor having a tip magnet attached thereto;
a drive motor electrically connected to said vibrator motor;
a disc having one or more magnets thereon; and
a shaft interconnecting said disc and said drive motor, wherein said tip magnet is positioned generally opposite said one or more magnets on said disc and with the polarity of said tip magnet and said one or more magnets selected to rotatably drive said disc and said shaft so as to operate said drive motor in reverse as a generator to produce electricity from said drive motor to recharge said rechargeable battery.

2. The light emitting unit of claim 1 further comprising a safety circuit disposed between said rechargeable battery and said light emitting device to limit operation and protect said light emitting unit.

3. The light emitting unit of claim 1 further comprising a photocell electrically connected to said battery and said vibrator motor, said photocell configured to selectively allow operation of said light emitting unit when sunlight is not sufficiently available, engaging said rechargeable battery to initiate start-up of said light emitting unit.

4. A light emitting unit for producing light energy, comprising:
a rechargeable battery;
a light emitting device electrically connected to said rechargeable battery;
a safety circuit disposed between said rechargeable battery and said light emitting device to limit operation and protect said light emitting unit;
a vibrator motor electrically connected to said rechargeable battery, said vibrator motor having a tip magnet attached thereto;
a photocell electrically connected to said battery and said vibrator motor, said photocell configured to selectively allow operation of said light emitting unit when sunlight is not sufficiently available, engaging said rechargeable battery to initiate start-up of said light emitting unit;
a drive motor electrically connected to said vibrator motor;
a disc having one or more magnets thereon; and
a shaft interconnecting said disc and said drive motor, wherein said tip magnet is positioned generally opposite said one or more magnets on said disc and with the polarity of said tip magnet and said one or more magnets selected to rotatably drive said disc and said shaft so as to operate said drive motor in reverse as a generator to produce electricity from said drive motor to recharge said rechargeable battery.

5. A light emitting system for continuously producing electricity for use to power a light-powered electricity generating apparatus, said system comprising:
a rechargeable battery;
a light emitting device electrically connected to said rechargeable battery, said light emitting device configured to direct light energy toward said electricity generating apparatus so as to produce electricity therefrom;
a vibrator motor electrically connected to said rechargeable battery, said vibrator motor having a tip magnet attached thereto;
a drive motor electrically connected to said vibrator motor;
a disc having one or more magnets thereon; and
a shaft interconnecting said disc and said drive motor, wherein said tip magnet is positioned generally opposite said one or more magnets on said disc and with the polarity of said tip magnet and said one or more magnets selected to rotatably drive said disc and said shaft so as to operate said drive motor in reverse as a generator to produce electricity from said drive motor to recharge said rechargeable battery, provide electrical power for said light emitting device so as to power said electricity generating apparatus.

6. The light emitting system of claim 5 further comprising a photocell electrically connected to said battery and said vibrator motor, said photocell configured to selectively allow operation of said light emitting unit when sunlight is not sufficiently available, engaging said rechargeable battery to initiate start-up of said system.

7. The light emitting system of claim 6 further comprising a safety circuit disposed between said rechargeable battery and said light emitting device to limit operation and protect said system.

8. The light emitting system of claim 5 further comprising a safety circuit disposed between said rechargeable battery and said light emitting device to limit operation and protect said system.

9. The light emitting system of claim 5, wherein said electricity generating apparatus comprises a light-powered magnetically levitated device having a pair of drive shafts attached thereto so as to extend in opposite directions therefrom and rotate in response to light from said light emitting device, a drive shaft magnet on each of said one or more drive shafts configured to rotate with said drive shafts and a conductor element associated with each of said drive shaft magnets, each of said conductor elements having a stationary coil that one of said drive shaft magnets rotates relative thereto to produce electricity.

10. The light emitting system of claim 9, wherein said conductor elements are electrically connected to a grid-tie inverter configured to receive electricity from said conductor elements and distribute the electricity for use.

11. The light emitting system of claim 9, wherein said light-powered magnetically levitated device comprises a rotor block with one or more sidewalls, a photovoltaic panel on each of said one or more sidewalls, a first drive shaft attached to a first end of said rotor block so as to extend outwardly therefrom and rotate with said rotor block, a second drive shaft attached to a second end of said rotor block so as to extend outwardly therefrom and rotate with said rotor block, block wiring on said rotor block and a drive magnet magnetically engaged with said block wiring, said photovoltaic panels configured to convert the light from said light emitting device to electrical current, said block wiring electrically connected to said photovoltaic panels to receive the electrical current therefrom, said drive magnet positioned so as to magnetically engage said electrical current in said block wiring and rotate said rotor block causing rotation of each of said first drive shaft and said second drive shaft so as to generate electricity by movement of a magnetic field.

12. The light emitting system of claim 11, wherein said light-powered magnetically levitated device further comprises a first support magnet on said first drive shaft, one or more first base magnets disposed in spaced apart relation to said first support magnet so as to levitate said first drive shaft, a second support magnet on said second drive shaft and one or more second base magnets disposed in spaced apart relation to said second support magnet so as to levitate said second drive shaft.

13. The light emitting system of claim 12, wherein said conductor elements are electrically connected to a grid-tie inverter configured to receive electricity from said conductor elements and distribute the electricity for use.
